(19) United States
(12) Patent Application Publication
(10) Pub. No.: US 2014/0091738 A1
(43) Pub. Date: Apr. 3, 2014

(54) Inverter Circuit having Switching Means Operating with Linear Operation

(71) Applicant: Stefan Butzmann, Beilstein (DE)

(72) Inventor: Stefan Butzmann, Beilstein (DE)

(73) Assignee: Robert Bosch GmbH, Stuttgart (DE)

(21) Appl. No.: 14/040,880

(22) Filed: Sep. 30, 2013

(30) Foreign Application Priority Data
Oct. 2, 2012 (DE) 10 2012 217 974.7

(51) Int. Cl. H02P 6/14; B60L 11/18

(52) U.S. Cl. CPC H02P 6/14; B60L 11/1803
USPC 318/139; 318/400.28

(57) ABSTRACT

An inverter circuit for an electric motor includes a first terminal and a second terminal, via which the inverter circuit is connectable to an energy store. The inverter circuit also includes a parallel circuit having three half-bridge circuits located between the first terminal and the second terminal. Each of the half-bridge circuits includes in each case two switching devices, between which a half-bridge terminal, via which the respective half-bridge circuit is connectable to a respective input of an electric motor, is arranged in each case. The two switching devices of at least one of the half-bridge circuits are in each case configured to be driven linearly and to be operated as a current source, while the respective other switching device of the at least one half-bridge circuit is in the on state.

This application claims priority under 35 U.S.C. §119 to patent application no. DE 10 2012 217 974.7, filed on Oct. 2, 2012 in Germany, the disclosure of which is incorporated herein by reference in its entirety.

### BACKGROUND

The present disclosure relates to an inverter circuit for an electric motor which has at least two switching devices which are designed to be driven linearly and to be operated as a current source.

A multiplicity of different inverters or inverter circuits for driving electric motors, in particular three-phase motors, are known from the prior art. By way of example, DE 196 00 807 A1 discloses an intelligent isolated half-bridge power module having at least one power transistor, with which an electric motor can be driven.

Another inverter circuit from the prior art for driving an electric motor is illustrated in FIG. 1. Said circuit has a parallel circuit 15 comprising three half-bridge circuits 10. Each of the three half-bridge circuits 10 comprises two switching devices 8 which are connected in series with one another within the half-bridge circuit 10. A half-bridge terminal 6, via which the respective half-bridge circuit 10 of the inverter circuit 20 is connectable to an input of an electric motor, is arranged in each case between the two switching means 8 within each half-bridge circuit 10. In order to drive an electric motor of this type, at most one of the two switching means 8 within each half-bridge circuit 10 is switched on, while the respective other switching means 8 within the half-bridge circuit 10 is switched off. Furthermore, the inverter circuit 20 has a first and a second terminal 11, 12, between which the parallel circuit 15 comprising the half-bridge circuits 10 is arranged. In this case, the first terminal 11 is also connected to a first electrode of an intermediate circuit capacitor 9, while the second terminal 12 is connected to the second electrode of the intermediate circuit capacitor 9. The intermediate circuit capacitor 9 is in this case one of the most important components of a so-called DC voltage intermediate circuit arranged between the terminals 11, 12. If the inverter circuit 20 is connected to an energy store or a battery system and an electric motor, the energy from the energy store or from the electric motor, when it is operated as a generator, is buffer-stored as fed-back energy in the intermediate circuit capacitor of the DC voltage intermediate circuit.

In the case of so-called recuperation, that is to say the aforesaid feeding back of energy from the electric motor into the battery system, it can occur that the contactors of the battery system and therefore the electrical connection between the battery system and the inverter circuit must be opened for reasons of safety. In this case, the voltage in the DC voltage intermediate circuit or the voltage across the intermediate circuit capacitor increases sharply. The intermediate circuit capacitor in inverter circuits of the prior art must therefore be relatively large in size in order to limit the voltage increase across the same. However, large intermediate circuit capacitors of this type are expensive and have a large space requirement.

Therefore, some approaches which aim to reduce the size of the intermediate circuit capacitor are already known from the prior art. Thus, for example DE 102 18 305 A1 discloses a resonant inverter circuit having six main switch elements which can be switched either on or off by means of a circuit controller, wherein three groups of in each case two main switch elements in each case contain one phase of a three-phase bridge and are connected to a three-phase bridge. Here, each of said main switch elements is assigned an surge capacitor.

### SUMMARY

The disclosure provides an inverter circuit for an electric motor, which comprises a first and a second terminal, via which the inverter circuit is connectable to an energy store. The inverter circuit also comprises a parallel circuit comprising three half-bridge circuits which is arranged between the first and second terminal, wherein each of the half-bridge circuits has in each case two switching devices, between which a half-bridge terminal, via which the respective half-bridge circuit is connectable to a respective input of an electric motor, is arranged in each case. According to the disclosure, the two switching devices of at least one of the half-bridge circuits are in each case configured to be driven linearly and to be operated as a current source, while the respective other switching device of the half-bridge circuit is in the on state.

An inverter circuit according to the disclosure enables the operation of an electric motor connected to the inverter circuit with a simultaneous active reduction of the voltage drop across an intermediate circuit capacitor connected to the inverter circuit. Therefore, in the configuration of the inverter circuit, an intermediate circuit capacitor with smaller dimensions compared to the prior art can be provided. If the non-conducting switching means in a half-bridge circuit of the inverter circuit is not switched off but rather is operated as a current source, the voltage drop across the DC voltage intermediate circuit can therefore be reduced and a smaller intermediate circuit capacitor compared to the inverter circuits of the prior art can be installed or used.

In a preferred embodiment, the first terminal is connected to the first electrode of an intermediate circuit capacitor and the second terminal is connected to the second electrode of the intermediate circuit capacitor. As a result, the inverter circuit according to the disclosure is fixedly connected to an intermediate circuit capacitor.

Preferably, a first terminal of at least one switching means of at least one half-bridge circuit is connected to the cathode of a protective diode, while the second terminal of said at least one switching means is connected to the anode of the protective diode. Protective diodes are semiconductor diodes which can be used readily to protect against overvoltages and impermissible voltages.

Preferably, the protective diode is embodied as a freewheeling diode. An advantage of using a freewheeling diode is that high currents can be limited very precisely to a very low value thereby.

In a preferred embodiment, the switching means of the half-bridge circuits are embodied as transistors. Electrical signals can be switched and amplified with transistors without a mechanical movement having to be performed for this. Transistors are immediately ready for operation on application of an operating voltage. They have low losses, a very low generation of heat and very small dimensions.

The transistors of the half-bridge circuit are preferably embodied as IGBTs. An IGBT (insulated-gate bipolar transistor) can be considered to be a combination of a field-effect transistor and a bipolar transistor in which an N-channel field-effect transistor drives a PNP bipolar transistor. Therefore, in terms of the drive properties, the IGBT, like the field-effect transistor, should be considered to be a voltage-controlled component which has a gate electrode. However, the other properties are similar to those of a bipolar transistor. An IGBT is driven without power like a field-effect transistor. Owing to the internal construction thereof, the IGBT is also available for significantly higher operating voltages compared to the field-effect transistor and has lower losses during operation.

Preferably, the switching means of all of the half-bridge circuits are configured to be driven linearly and to be operated as a current source, while the respective other switching means of the half-bridge circuit is in the on state. In one such embodiment of the inverter circuit according to the disclosure, the power loss occurring during operation is distributed across the half-bridge circuits with the greatest uniformity.

Furthermore, a battery having an inverter circuit according to the disclosure is provided, wherein the battery is particularly preferably embodied as a lithium-ion battery. Advantages of batteries of this type are, inter alia, their comparatively high energy density and their high thermal stability. A further advantage of lithium ion batteries is that they are not subject to any memory effect.

In addition, a motor vehicle having a battery having an inverter circuit according to the disclosure is provided, wherein the battery is connected to a drive system of the motor vehicle.

Advantageous developments of the disclosure are specified in the subclaims and described in the description.

### BRIEF DESCRIPTION OF THE DRAWINGS

Exemplary embodiments of the disclosure are explained in more detail on the basis of the drawings and the description below. In the drawings:

FIG. 1 shows an inverter circuit according to the prior art for driving an electric motor,

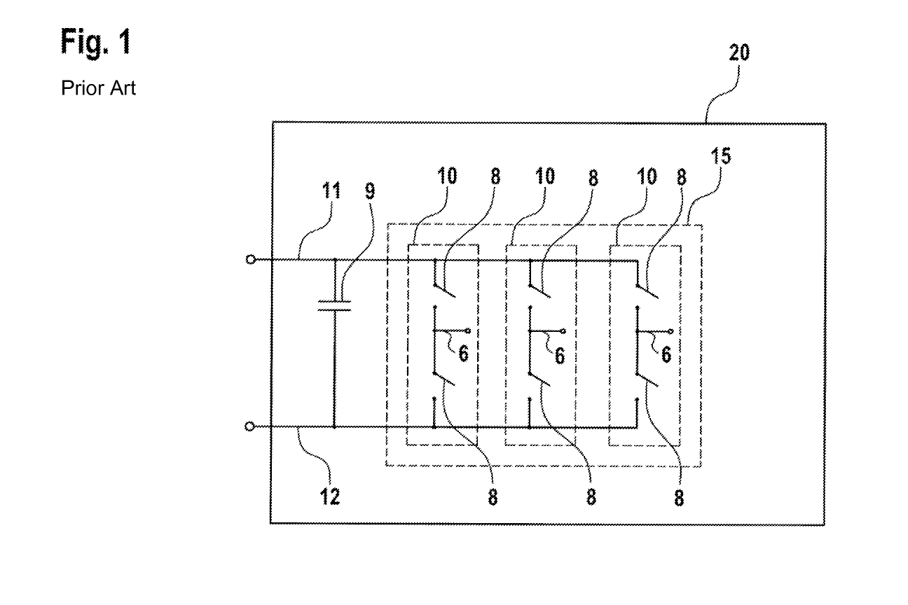

FIG. 2 shows an embodiment of an inverter circuit according to the disclosure, and

FIG. 3 shows a half-bridge circuit of an inverter circuit according to the disclosure for illustrating the currents flowing through the half-bridge circuit.

### DETAILED DESCRIPTION

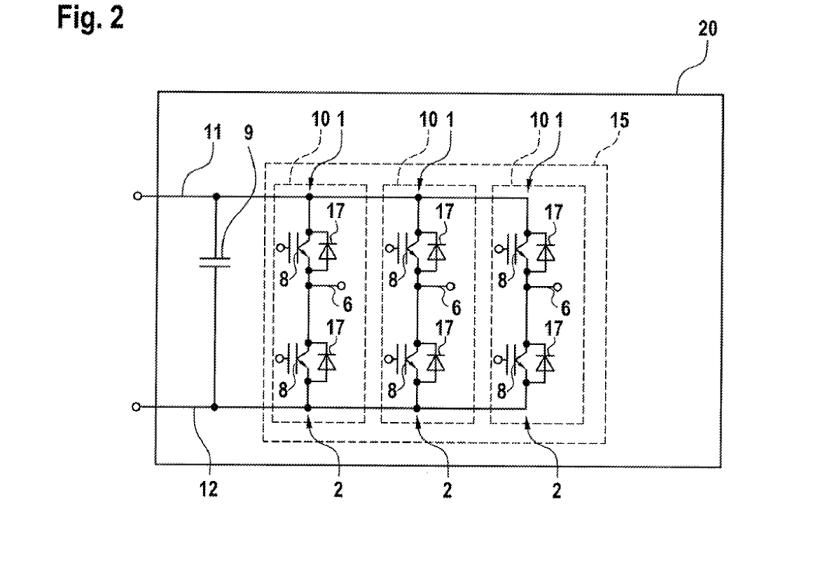

FIG. 2 illustrates an embodiment of an inverter circuit 20 according to the disclosure. Said inverter circuit can be used to drive an electric motor, in particular a three-phase motor. The inverter circuit 20 according to the disclosure has two terminals 11, 12, between which a parallel circuit 15 comprising three half-bridge circuits 10 is arranged, the three half-bridge circuits each having two switching means 8. In other words, the first terminal 11 of the inverter circuit 20 is connected to the first ends 1 of the half-bridge circuits 10, while the second terminal 12 of the inverter circuit 20 is connected to the second ends 2 of the half-bridge circuits 10. In this case, the in each case two switching means 8 within one half-bridge circuit 10 are connected in series with one another. In each case between the two switching means 8 within each half-bridge circuit 10, the half-bridge circuits 10 have in each case one half-bridge terminal 6. Each half-bridge circuit 10 is connectable to in each case one input of an electric motor or to a phase of a three-phase bridge via said half-bridge terminal 6. Thus, by means of in each case one half-bridge terminal 6, the inverter circuit 20 is connectable, for example, to one of the u, v or w three-phase terminals of a three-phase motor. In other words, the inverter circuit 20 has six switching means 8, two of which form a group in each case. Within said groups, the in each case two switching means 8 form a series circuit or the two switching means 8 are connected in series with one another. In each case the first end of said series circuits or the first end 1 of said half-bridge circuits 10, that is to say in each case the first terminal of the first switching means 8 in each group, is connected to the first terminal 11 of the inverter circuit 20, while the second end of the series circuits or the second end 2 of the half-bridge circuits 10, that is to say in each case the second terminal of in each case the second switching means 8 in each group, is connected to the second terminal 12 of the inverter circuit 20. The electrical connection between two switching means 8 of each series circuit of a group is connectable to one of the inputs of an electric motor.

If, therefore, the inverter circuit 20 is connected by means of its terminals 11, 12, for example, to a battery system and additionally to the u, v and w three-phase terminals of a three-phase motor via the half-bridge terminals 6, a respective one of the u, v or w three-phase terminals can be connected to either the positive or the negative pole of the battery system by means of a specific driving of the switching means 8.

In the exemplary embodiment of the inverter circuit 20 according to the disclosure illustrated in FIG. 2, an intermediate circuit capacitor 9 is connected between the terminals 11, 12 of the inverter circuit 20. In other words, the first terminal 11 of the inverter circuit 20 is connected to a first electrode of the intermediate circuit capacitor 9, while the second terminal 12 of the inverter circuit 20 is connected to the second electrode of the intermediate circuit capacitor 9. In this case, the use of an intermediate circuit capacitor 9 in an inverter circuit 20 according to the disclosure is purely optional. Inverter circuits 20 according to the disclosure can also be embodied without an intermediate circuit capacitor 9. Inverter circuits 20 of this type can then be connectable, for example via the terminals 11, 12 thereof, to a DC voltage intermediate circuit. The level of the capacitance of the intermediate circuit capacitor 9 or the law for determining the same has been selected purely by way of example in this exemplary embodiment.

In this exemplary embodiment, all six switching means 8 are embodied as IGBTs. Although the embodiment as IGBTs is preferred in this case, it is not imperative. Inverter circuits 20 according to the disclosure which have other types of switching means 8, for example MOSFETs or other bipolar transistors, can also be implemented. Furthermore, different types of switching means 8 can also be used next to one another within an inverter circuit 20.

In addition, in this exemplary embodiment, each switching means 8 is assigned in each case a protective diode 17 embodied as a freewheeling diode. In this case, in each case the first terminal of a switching means 8 in this exemplary embodiment is connected in each case to the cathode of the freewheeling diode assigned in each case to the switching means 8, while in each case the second terminal of the respective switching means 8 is connected to the anode of the freewheeling diode assigned in each case to the switching means 8. As a result, the freewheeling diodes of all the switching means 8 within the inverter circuit 20 have the same orientation. In other words, the switching path of each switching means 8 within the half-bridge circuits 10 is connected in parallel with a protective diode 17. In this case, the use of a protective diode 17 within an inverter circuit 20 according to the disclosure is purely optional and the orientation thereof and embodiment as a freewheeling diode in this exemplary embodiment has been selected purely by way of example. Inverter circuits 20 according to the disclosure in which only some of the switching means 8 are connected to protective diodes 17 can also be implemented. In other words, inverter circuits 20 according to the disclosure in which in each case the first terminal of a switching means 8 is connected in each case to the anode of a freewheeling diode assigned in each case to one of the switching means 8, while in each case the second terminal of the respective switching means 8 is connected to the cathode of a freewheeling diode assigned in each case to the switching means 8 can also be implemented.

According to the disclosure, in the exemplary embodiment in FIG. 2, all of the switching means 8 of the half-bridge circuits 10 of the inverter circuit 20 are designed to be driven linearly and to be operated as a current source, while the respective other switching means 8 of a respective half-bridge circuit 10 is in the on state. In other words, it is possible to operate the switching means 8 of the half-bridge circuits in a state which is between the high-resistance and low-resistance states of the switching means 8. It is possible, therefore, to incompletely turn on any particular switching means 8 within a half-bridge circuit 10 of the inverter circuit 20 according to the disclosure while the other switching means 8 within the respective half-bridge circuit 10 is in the on state or completely turned on. Therefore, within a half-bridge circuit 10, one switching means 8 can be switched on while the remaining switching means 8 of the half-bridge circuit 10 is not switched off but rather is operated as a current source or with linear operation, in other words is not operated in the completely turned-on state. As a result, the voltage drop across the switching means 8, which is not switched off but rather operated linearly as a current source in contrast to the prior art, is reduced. In this case, not all of the switching means 8 in an inverter circuit 20 according to the disclosure have to be configured to be driven linearly and to be operated as a current source while the respective other switching means 8 of the respective half-bridge circuit 10 is in the on state. Inverter circuits 20 according to the disclosure in which only the switching means 8 within one or two half-bridge circuit(s) 10 are configured to be driven linearly and to be operated as a current source while the respective other switching means 8 of the respective half-bridge circuit 10 is in the on state can also be implemented.

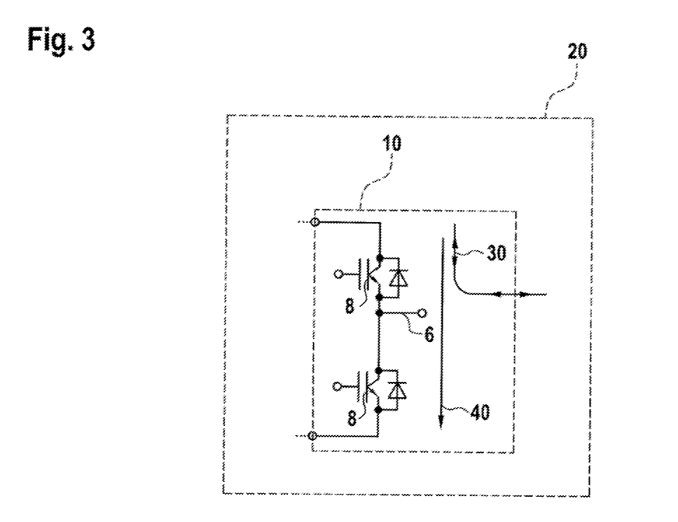

FIG. 3 shows a half-bridge circuit 10 of an inverter circuit 20 according to the disclosure to illustrate the currents flowing through the half-bridge circuit 10. The half-bridge circuit 10 illustrated in FIG. 3 is in this case implemented like a half-bridge circuit 10 of the exemplary embodiment illustrated in FIG. 2. Furthermore, the half-bridge circuit 10 in FIG. 3 is arranged or connected within an inverter circuit 20 identical to that in the exemplary embodiment illustrated in FIG. 2. In the exemplary embodiment in FIG. 3, the inverter circuit 20, of which only one half-bridge circuit 10 is illustrated, is connected via the terminals thereof to a battery system and via the half-bridge terminals 6 to an electric motor. Currents flowing within the half-bridge circuit 10 are indicated by arrows in FIG. 3, with regard to the direction of current flow, in each case next to the electrical connections of the half-bridge circuit in which the currents actually flow. In this case, FIG. 3 shows the case in which the upper switching means 8 of the half-bridge circuit 10 is turned on, that is to say is in the on state, while the lower switching means 8 of the half-bridge circuit 10 is operated linearly, that is to say operated as a current source. During normal operation and during recuperation of the electric motor, the current flows 30 (current flow to or from the motor) and 40 (limit current) through the half-bridge circuit 10, as illustrated in FIG. 3 are produced. If, by contrast, the lower switching means 8 within the half-bridge circuit 10 is turned on, that is to say is switched on, the upper switching means 8 of the half-bridge circuit 10 is operated as a current source or with linear operation. In this case, other current flows (not illustrated in FIG. 3) are then produced.

What is claimed is:

1. An inverter circuit for an electric motor, comprising:
a first terminal and a second terminal configured to be connected to an energy store; and
a parallel circuit including three half-bridge circuits, the parallel circuit being arranged between the first terminal and the second terminal, each half-bridge circuit of the three half-bridge circuits including two switching devices and a half-bridge terminal located between the two switching devices via which the respective half-bridge circuit is connectable to a respective input of an electric motor, the two switching devices of at least one of the half-bridge circuits are in each case configured to be driven linearly and to be operated as a current source, while the respective other switching device of the at least one half-bridge circuit is in the on state.

2. The inverter circuit according to claim 1, wherein:
the first terminal is connected to a first electrode of an intermediate circuit capacitor, and
the second terminal is connected to a second electrode of the intermediate circuit capacitor.

3. The inverter circuit according to claim 1, wherein:
a first terminal of at least one switching device of at least one half-bridge circuit is connected to a cathode of a protective diode, and
a second terminal of the at least one switching device is connected to an anode of the protective diode.

4. The inverter circuit according to claim 3, wherein the protective diode includes a freewheeling diode.

5. The inverter circuit according to claim 1, wherein the switching devices of the three half-bridge circuits include a plurality of transistors.

6. The inverter circuit according to claim 5, wherein the plurality of transistors are embodied as IGBTs.

7. The inverter circuit according to claim 1, wherein the switching devices of all of the three half-bridge circuits are in each case configured to be driven linearly and to be operated as a current source, while the respective other switching device is in the on state.

8. A battery comprising:
an inverter circuit for an electric motor, the inverter circuit including
a first terminal and a second terminal configured to be connected to an energy store, and
a parallel circuit including three half-bridge circuits, the parallel circuit being arranged between the first terminal and the second terminal, each half-bridge circuit of the three half-bridge circuits including two switching devices and a half-bridge terminal located between the two switching devices via which the respective half-bridge circuit is connectable to a respective input of an electric motor, the two switching devices of at least one of the half-bridge circuits are in each case configured to be driven linearly and to be operated as a current source, while the respective other switching device of the at least one half-bridge circuit is in the on state.

9. A motor vehicle comprising:
a battery connected to a drive system of the motor vehicle, the battery including an inverter circuit for an electric motor, the inverter circuit including
a first terminal and a second terminal configured to be connected to an energy store, and
a parallel circuit including three half-bridge circuits, the parallel circuit being arranged between the first terminal and the second terminal, each half-bridge circuit of the three half-bridge circuits including two switching devices and a half-bridge terminal located between the two switching devices via which the respective half-bridge circuit is connectable to a respective input of an electric motor, the two switching devices of at least one of the half-bridge circuits are in each case configured to be driven linearly and to be operated as a current source, while the respective other switching device of the at least one half-bridge circuit is in the on state.
